(19) United States
(12) Patent Application Publication
(10) Pub. No.: US 2009/0202829 A1
(43) Pub. Date: Aug. 13, 2009

(54) Long Fiber-Reinforced Thermoplastic Concentrate and Method for Its Preparation

(76) Inventors: Richard T. Fox, Midland, MI (US); Vijay Wani, Pearland, TX (US); Ludo M. Aerts, Eksaarde (BE); Robert W. Ranger, Midland, MI (US); Gary D. Parsons, Midland, MI (US)

Correspondence Address: The Dow Chemical Company, Intellectual Property Section, P.O. Box 1967, Midland, MI, 48641-1967, US

(21) Appl. No.: 12/223,451

(22) PCT Filed: Jun. 30, 2006
(86) PCT No.: PCT/US2006/026434

§ 371 Date: Jul. 24, 2008

Related U.S. Application Data
(60) Provisional application No. 60/697,324, filed on Jul. 7, 2005.

(51) Int. Cl. B32B 5/12; B05D 7/00; B29C 49/00; B29C 45/00; B29C 47/00

(52) U.S. Cl. 428/375; 427/212; 264/500; 264/328.1; 264/176.1

(57) ABSTRACT

Disclosed is a process to make a long fiber-reinforced thermoplastic concentrate wherein a continuous fiber strand is coated with an aqueous melt-kneaded thermoplastic dispersion, dried, and chopped.

### FIELD OF THE INVENTION

This invention relates to a long fiber-reinforced thermoplastic concentrate in the form of pellets having fibers with substantially the same length and in parallel in the same direction in a matrix of a thermoplastic resin and a method to make such pellets.

### BACKGROUND OF THE INVENTION

Long-fiber-reinforced thermoplastic resins have been widely used for various industrial product components because they possess excellent mechanical strength, heat resistance, and formability. It is difficult to produce a long fiber-reinforced thermoplastic resin by kneading cut fibers with a thermoplastic resin in an extruder. On the other hand, it is known that long fiber-reinforced thermoplastic resins can be made from long fiber-reinforced thermoplastic concentrates.

Long fiber-reinforced thermoplastic concentrates are known to be produced by melt pultrusion processes. In melt protrusion, a fiber strand is pulled through a thermoplastic melt and becomes wetted with the molten matrix polymer or carrier resin. Post forming or stripping means are used to set a consistent fiber content.

However, fiber levels typically do not exceed between 50 to 70 weight percent of the weight of the concentrate. Owing to the high viscosity of thermoplastic melts, incomplete penetration of the fiber with resin may occur during pultrusion. To achieve adequate penetration of the fiber strand by the melt, commonly used pultrusion processes use very low molecular weight thermoplastics as the carrier resin. However, even low levels of low molecular thermoplastic carrier resins present in a long fiber-reinforced thermoplastic concentrate can have deleterious effects on the mechanical strength, heat resistance, and formability of the non-reinforced thermoplastic resin to which the concentrate is added.

In processes described in U.S. Pat. Nos. 4,626,306; 4,680,224; 5,725,710; 5,888,580, and 6,045,912 a liquid polymer powder dispersion is used for impregnating the fiber strand. The thermoplastic powder, typically a low molecular weight thermoplastic, is applied to the fiber strand moving in longitudinal direction through the powder dispersion, the dispersing medium, a solvent or preferably water, is removed from the strand, for example by heating, then the thermoplastic melted, and the composite is consolidated, for example by rolling.

In these processes, the deposition of constant quantities of powder on the fiber strand moving through the dispersion bath presents problems. The polymer content of the composite depends on the solids content of the dispersion bath. The concentration in the immediate vicinity of the strand fluctuates and does not always correspond precisely to the average concentration of the subsequently supplied dispersion. Numerous remedies have been proposed, such as guides, strand measuring calibration devices, concentration control of the liquid polymer powder dispersion bath, etc., which are either economically unfeasible and/or met with little practical success.

Alternatively, aqueous dispersions of thermoplastic resins have been produced by a process wherein a polymerizable monomer which is the resin raw material is polymerized by emulsion polymerization in an aqueous medium in the presence of an emulsifying agent. Advantageously, emulsion polymerized may produce high molecular weight thermoplastic resins. However, this process is limited by the few number of polymerizable monomers that can be used, and hence, the number of aqueous dispersions of thermoplastic resins that can be produced is limited.

Thus, it would be desirable to provide an economical process to provide a long fiber-reinforced thermoplastic concentrate with a high and consistent fiber content combined with a thermoplastic carrier resin having increased molecular weight. The present invention is such a long fiber-reinforced thermoplastic concentrate.

### SUMMARY OF THE INVENTION

It is an object of the present invention to prepare a long fiber-reinforced thermoplastic concentrate which can be mixed at an extruder and/or a blow molding machine and/or injection molding machine hopper with a non-reinforced thermoplastic. Said concentrate provides a high and consistent fiber content combined with a thermoplastic carrier resin having increased molecular weight and economics competitive with direct mixing of bare long fibers and thermoplastic resin. Preferably, the long fiber-reinforced thermoplastic concentrate is provided as a pellet.

It is a further object of the present invention to provide a long fiber-reinforced thermoplastic concentrate with a thermoplastic carrier resin of the same type as and/or chosen to be compatible with the non-reinforced thermoplastic resin which it is ultimately intended to be mixed with in the extruder and/or injection molding machine. Preferably, the thermoplastic carrier resin has a molecular weight compatible to the non-reinforced thermoplastic resin it is being mixed with.

It is a further objective of the present invention to provide a long fiber-reinforced thermoplastic concentrate wherein the fiber content is in a substantially parallel direction for substantially the entire length of the pellet.

It is a further object of the present invention to provide a method for preparing high long fiber content pellets of the long fiber-reinforced thermoplastic concentrate of the present invention, preferably greater than about 50 weight percent, more preferably greater than about 90 weight percent.

The foregoing objects of the present invention are provided by a method to produce a long fiber concentrate comprising fibers and a thermoplastic resin comprising the steps of i) coating continuous fibers with an aqueous melt-kneaded thermoplastic dispersion to form thermoplastic coated continuous fiber strands, ii) heating the thermoplastic coated continuous fiber strands, iii) chopping the dried thermoplastic coated continuous fiber strands forming dried long fiber concentrate pellets, and iv) isolating dried long fiber concentrate pellets.

Alternatively, the foregoing objects of the present invention are provided by a method to produce a long fiber concentrate comprising fibers and a thermoplastic resin comprising the steps of i) coating continuous fibers with an aqueous melt-kneaded thermoplastic dispersion to form thermoplastic coated continuous fiber strands, ii) chopping the thermoplastic coated continuous fiber strands forming long fiber concentrate pellets, iii) heating the long fiber concentrate pellets, and iv) isolating dried long fiber concentrate pellets.

Alternatively, the foregoing objects of the present invention are provided by a method to produce a long fiber concentrate comprising fibers and a thermoplastic resin comprising the steps of i) coating chopped long fibers with an aqueous melt-kneaded thermoplastic dispersion to form thermoplastic coated chopped fiber pellets, ii) heating the coated chopped long fiber concentrate pellets, and iii) isolating dried long fiber concentrate pellets.

In one embodiment of the method of the present invention, the aqueous melt-kneaded thermoplastic dispersion comprises a thermoplastic resin, a dispersing agent, and water, preferably comprising from about 0.5 to about 30 parts per weight dispersing agent and from about 1 to about 35 parts per weight water, parts by weight are based on 100 parts by weight of the thermoplastic resin.

In another embodiment, the aqueous thermoplastic dispersion as produced can be further diluted so that it contains from about 10 to about 70 weight percent thermoplastic resin, preferably from about 15 to about 55, and more preferably from about 20 to about 45 weight percent thermoplastic resin.

The thermoplastic resin used in the dispersion of the method of the present invention is polyethylene, polypropylene, polyamide, polyethylene terephthalate, polybutylene terephthalate, a styrene and acrylonitrile copolymer, an acrylonitrile, styrene, and butadiene terpolymer, polyphenylene oxide, polyacetal, polyetherimide, polycarbonate, or blends thereof; preferably the polyethylene resin is an ethylene and alpha-olefin copolymer and the polypropylene resin is a propylene-rich alpha-olefin copolymer; and more preferably, the ethylene copolymer is a substantially linear ethylene polymer or a linear ethylene polymer and the propylene-rich copolymer comprises at least about 60 weight percent of units derived from propylene and at least about 0.1 weight percent of units derived from ethylene made using a nonmetallocene metal-centered, heteroaryl ligand catalyst characterized as having ¹³C NMR peaks corresponding to a region-error at about 14.6 and about 15.7 parts per million wherein these peaks are about equal in intensity.

The dispersing agent used in the dispersion of the method of the present invention is a carboxylic acid, a salt of a carboxylic acid, a carboxylic acid ester, a salt of an acid ester, an ethylene carboxylic acid polymer, a salt of an ethylene carboxylic acid polymer, an alkyl ether carboxylate, a petroleum sulfonate, a sulfonated polyoxyethylenated alcohol, a sulfated polyoxyethylenated alcohol, a phosphated polyoxyethylenated alcohol, a polymeric ethylene oxide/propyleneoxide/ethylene oxide dispersing agent, a primary alcohol ethoxylate, a secondary alcohol ethoxylate, an alkyl glycoside, an alkyl glyceride, or combinations thereof; preferably montanic acid, an alkali metal salt of montanic acid, an ethylene acrylic acid copolymer, an ethylene methacrylic acid copolymer, or combinations thereof.

The dispersion used in the method of the present invention preferably has a volume average particle size of less than about 5 micrometers, a pH of less than 12, or a volume average particle size of less than about 5 micrometers, a pH of less than about 12, and the dispersing agent comprises less than about 4 percent by weight based on the weight of the thermoplastic resin.

The fiber used in the method of the present invention preferably is a continuous fiber, for example a natural fibers, a glass fiber, a carbon fiber, a polypropylene fiber; a polyamide fiber, a polytetrafluoroethylene fiber, a polyester fiber, or an ultra high molecular weight polyethylene fiber, most preferably a glass fiber.

Another embodiment of the present invention is a fiber-reinforced thermoplastic composition comprising a thermoplastic resin and the long fiber-reinforced thermoplastic concentrate of the present invention.

A further embodiment of the present invention is an injection molded, a blow molded, or extruded thermoplastic article made from a fiber-reinforced thermoplastic composition comprising a thermoplastic resin and the long fiber-reinforced thermoplastic concentrate of the present invention.

### BRIEF DESCRIPTION OF THE DRAWINGS

FIG. 1 is a block flow diagram showing an apparatus suitable for practicing the process of the present invention.

FIG. 2 is a block flow diagram showing an alternative apparatus suitable for practicing the process of the present invention.

### DETAILED DESCRIPTION OF THE INVENTION

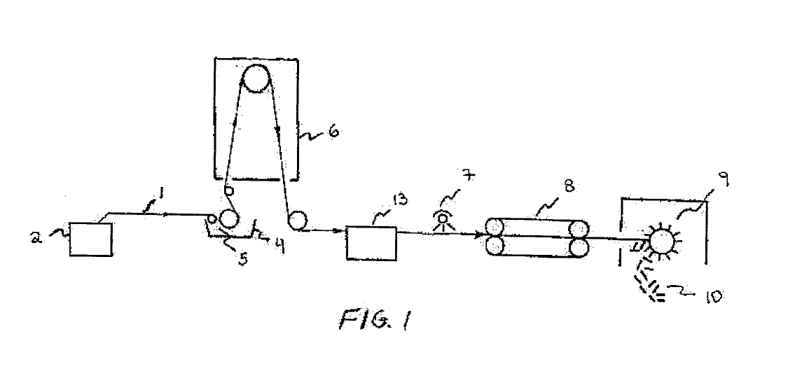

In the method as practiced in FIG. 1, a continuous fiber strand, or roving, 1 is fed from a supply reel 2 through a bath 4 containing an aqueous melt-kneaded thermoplastic dispersion 5 forming a coated strand. The coated strand is air dried or optionally passed through a heat source such as an oven 6 in which the water of the dispersion is driven off, i.e., the strand is dried, and/or the thermoplastic resin is fused. The coated strand after solidification of the thermoplastic resin may optionally pass near one or more heaters 7 where the strand is further dried and/or the temperature of the strand is raised, when required to an appropriate temperature wherein it will be ready for pelletizing in unit 9 to form pellets of the long fiber-reinforced thermoplastic concentrate of the invention. The strand may be drawn through the apparatus by the pelletizing unit 9 or optionally, a draw-off device 8. Optionally, the coated strand may be passed through a shaping device 13 at any point between the bath 4 and the pelletizing unit 9.

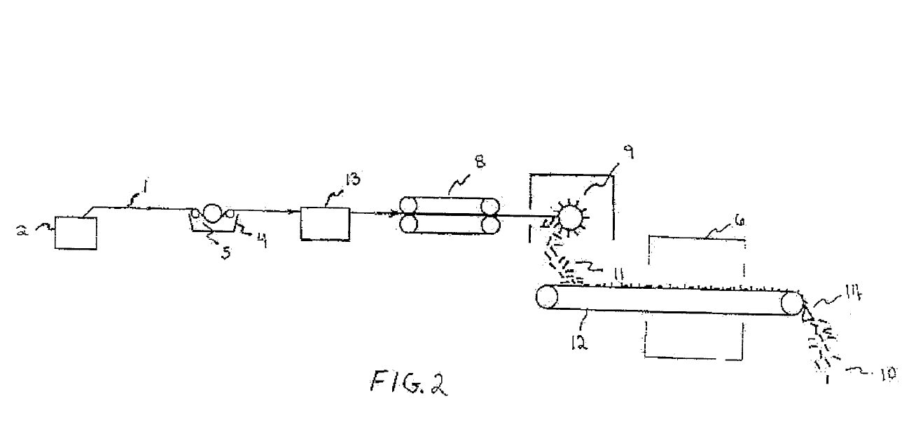

Alternatively, in the method as practiced in FIG. 2, a continuous fiber strand, or roving, 1 is fed from a supply reel 2 through a bath 4 containing an aqueous melt-kneaded thermoplastic dispersion 5. The coated strand is next passed through a pelletizer 9, or other chopping device, comminuting the coated strand into pre-dried pellets 11 which fall onto a conveyer belt 12 which allows for the pre-dried pellets to air dry or optionally passes the pre-dried pellets 11 through a heat source such as an oven 6 in which the water of the dispersion is driven off, i.e., the pre-dried pellets 11 are dried, and/or the thermoplastic resin is fused providing pellets 10 of the long fiber-reinforced thermoplastic concentrates of the invention. If necessary, the dried pellets scraped from the conveyer belt by a scraper 14. The strand may be drawn through the apparatus by the pelletizing unit 9 or optionally, a draw-off device 8. Optionally, the coated strand may be passed through a shaping device 13 at any point between the bath 4 and the pelletizing unit 9. Any method to transport the predried pellets 11 to the oven 6 is acceptable, for example in alternative to a conveyer belt, transporting them with a stream such as a stream of air.

As a process for producing the long fiber-reinforced thermoplastic concentrate of the present invention, a process other than the ones described hereinabove, may be employed. For example, the fiber bundle may be cut into a prescribed length to obtain chopped strands, then a thermoplastic resin dispersion may be coated on the chopped strands by a method such as spraying, followed by heating to obtain dried and/or fused pellets.

The preferred method of applying the thermoplastic resin to the fiber is a continuous method, wherein the roving strands are passed through a bath of an aqueous melt-kneaded thermoplastic dispersion. If desired, the strands may be opened by any suitable means prior to introduction into the bath of aqueous melt-kneaded thermoplastic dispersion or while immersed in the resin bath, and the amount of resin picked up by the strand is controlled by one or more of the following:

a. speed of strand through the dispersion,

b. concentration of the thermoplastic in the dispersion,

c. viscosity of the thermoplastic dispersion,

d. the degree to which the excess resin is wiped off by a suitable mechanism such as passing the strand through a shaping device, for example a restricting orifice.

After passage of the strand through the melt-kneaded thermoplastic dispersion, it can then be passed through an oven maintained above the softening temperature, for example, glass transition temperature or melting point, of the thermoplastic, typically 50° C. to 250° C. to remove water and/or other volatiles and to fuse the resin. The specific temperatures employed in the oven will depend upon the resins employed. As mentioned hereinabove, the strand may be passed through the oven before or after it has been chopped into long fiber pellets. If desired, the strand may be further heated prior to pelletizing in order to bring the strand to proper pelletizing temperature.

The pellets are three dimensional and may be described by their length, width, and height “h”. The longest dimension is its length “l”. “Long” fiber means fibers equal to or greater than 0.125 inch in length, whereas “short” fibers refer to fibers less than 0.125 inch in length. The long fiber-reinforced thermoplastic concentrate pellet of the present invention has a length equal to or greater than about 0.125 inch, preferably equal to or greater than about 0.188 inch, and most preferably equal to or greater than about 0.25 inch. The long fiber-reinforced thermoplastic concentrate pellet of the present invention has a length equal to or less than about 5 inches, preferably equal to or less than about 2.5 inches, even more preferably equal to or less than about 1 inch, even more preferably equal to or less than 0.5 inch, and most preferably equal to or less than about 0.313 inch.

The cross sectional shape of the pellet is not critical and is largely dependent on the intended application the long fiber-reinforced concentrate is used for and/or the design of the shaper 13. For example, the strand prior to pelletizing can be shaped like a ribbon, a rectangle, a square, a triangle, an oval, circular, a circle, or other possible geometric shapes, preferably circular or oval like. If the shape is not circular, it can be described by its width; “w” which is the second longest dimension after the length and the height “h” which is the smallest dimension. If the strand or resulting pellet is circular its width and height are about the same and its cross sectional shape may be described by its diameter “d”. Preferably, the smallest dimension of the pellet (i.e., h or d if circular) is equal to or greater than about 0.0156 inch, preferably equal to or greater than about 0.0313 inch, more preferably equal to or greater than about 0.0469 inch and most preferably about 0.0625 inch. Preferably, the smallest dimension of the pellet (i.e., h or d if circular) is equal to or less than about 0.25 inch, preferably equal to or less than about 0.188 inch, more preferably equal to or less than about 0.125 inch.

In the present invention, as the reinforcing material, it is preferred to employ a continuous fiber bundle having a predetermined number of fibers bundled together. Preferably a fiber bundle withdrawn from a bobbin formed by winding up a bundle of fibers into a barrel or cylindrical shape. Suitable fibers for use in the present invention are inorganic fibers such as glass fibers, carbon fibers, or organic fibers such as ones made from polypropylene; polyamide, for example, NYLON®; polytetrafluoroethylene, for example, TEFLON™; polyester, for example polybutylene terephthalate and polyethylene terephthalate; aromatic polyamide, for example, ARAMID™; ultra high molecular weight polyethylene, polybisbenzoxazole (PBO), natural fibers such as cotton, hemp, flax, jute, and the like. The fibers of the present invention may further be coated with a sizing to further improve compatibility between the fibers and the thermoplastic matrix resin. Sizings are well known in the art and a skilled practitioner can select an appropriate sizing for the specific fiber and thermoplastic used.

In the present invention the reinforcing material is present in the long fiber-reinforced thermoplastic concentrate in an amount of equal to or greater than about 30 weight percent, preferably equal to or greater than about 50 weight percent, more preferably equal to or greater than about 70 weight percent, even more preferably equal to or greater than about 85 weight percent, and most preferably equal to or greater than about 90 weight percent, wherein weight percent is based on the weight of the long fiber-reinforced thermoplastic concentrate. In the present invention the reinforcing material is present in the long fiber-reinforced thermoplastic concentrate in an amount of equal to or less than about 99 weight percent, preferably equal to or less than about 98 weight percent, more preferably equal to or less than about 97 weight percent, and most preferably equal to or less than about 95 weight percent, wherein weight percent is based on the weight of the long fiber-reinforced thermoplastic concentrate.

In addition to the fiber-reinforcing material the long fiber-reinforced concentrate of the present invention comprises a thermoplastic coating, sometimes referred to as the matrix or carrier resin. The thermoplastic coating is applied to the fiber as an aqueous thermoplastic melt-kneaded dispersion. The thermoplastic resin used in the aqueous thermoplastic melt-kneaded dispersion is not particularly limited, and it is possible to employ, for example, polyethylene (PE), polypropylene (PP), thermoplastic polyurethane (TPU), polyamide (PA), polyethylene terephthalate (PET), polybutylene terephthalate (PBT), a styrene and acrylonitrile copolymer (SAN), an acrylonitrile, styrene, and butadiene terpolymer (ABS), polyphenylene oxide (PPO) or sometimes referred to as polyphenylene ether (PPE), polyacetal, polyetherimide, polycarbonate (PC), blends thereof, for example, PC/ABS, PPO/PS, and the like.

In the present invention, the thermoplastic resin has a weight average molecular weight (Mw) of from about 5,000 to about 5,000,000, from about 20,000 to about 1,000,000, from about 100,000 to about 500,000, or from about 150,000 to about 300,000 and a weight average molecular weight/number average molecular weight (Mw/Mn, sometimes referred to as a “polydispersity index” (PDI)) ranging from a lower limit of 1.01, 1.5, or 1.8 to an upper limit of 20, 10, 5, or 3.

Preferably, when the thermoplastic resin matrix of the long fiber-reinforced thermoplastic concentrate of the present invention is added to the same type of non-reinforced thermoplastic resin, the matrix resin has a Mw compatible with the non-reinforced thermoplastic resin it is being combined with. As used herein, “compatible Mw” means a Mw of the long fiber-reinforced thermoplastic matrix resin that is within±75 percent of the Mw value for the non-reinforced resin, preferably±50 percent, more preferably±35 percent, even more preferably about±25 percent, and most preferably±10 percent of the Mw value for the non-reinforced resin.

Preferably, when the thermoplastic resin matrix of the long fiber-reinforced thermoplastic concentrate of the present invention is added to a different type of non-reinforced thermoplastic, the matrix resin has a viscosity compatible with the non-reinforced thermoplastic resin it is being combined with. As used herein, “compatible viscosity” means a viscosity of the long fiber-reinforced thermoplastic matrix resin that is within±75 percent of the viscosity value for the non-reinforced resin, preferably±50 percent, more preferably±35 percent, even more preferably about±25 percent, and most preferably±10 percent of the viscosity value for the non-reinforced resin. Viscosity values can be determined by any standard test method applicable to a specific thermoplastic.

Alternatively, “compatible” means that the addition of the matrix resin from the long fiber-reinforced thermoplastic concentrate of the present invention to the non-reinforced thermoplastic resin, whether it is the same type of thermoplastic resin or different, does not cause deleterious effects to the non-reinforced resin, for example, delamination, loss of physical properties, loss of thermal properties, loss of mechanical properties, loss of heat and/or color stability, or combinations thereof.

A preferred thermoplastic matrix resin is a copolymer, sometimes referred to as an interpolymer, of ethylene with a C₃ to C₂₀ alpha-olefin. A preferred ethylene and alpha-olefin copolymer is a polyolefin elastomer having a glass transition temperature less than 25° C., preferably less than 0° C. Examples of suitable polyolefin elastomers include ethylene and a copolymer with an alpha-olefin such as propylene (EPM), 1-butene, 1-hexene, and 1-octene, propylene and a diene copolymer such as hexadiene or ethylidene norbornene (EPDM). A particularly preferred polyolefin elastomer is a substantially linear ethylene polymer or linear ethylene polymer (S/LEP), both are well known. Substantially linear ethylene polymers and their method of preparation are fully disclosed in U.S. Pat. Nos. 5,272,236 and 5,278,272 and linear ethylene polymers and their method of manufacture are fully disclosed in U.S. Pat. Nos. 3,645,992; 4,937,299; 4,701,432; 4,937,301; 4,935,397; and 5,055,438 the disclosures of which are incorporated herein by reference.

Another preferred thermoplastic resin is polypropylene. The propylene polymer suitable for the present invention is syndiotactic, atactic or preferably isotactic. It can be a homopolymer or a copolymer with an alpha-olefin, preferably a C₂, or C₄ to C₂₀ alpha-olefin, for example, a random or block copolymer or preferably an impact propylene copolymer. The propylene polymer may also comprise a polyolefin elastomer such as those described hereinabove, preferably a substantially linear ethylene polymer or a linear ethylene polymer.

A preferred propylene polymer is a propylene-rich alpha-olefin copolymer or interpolymer comprising 5 to 25 weight percent ethylene-derived units and 95 to 75 weight percent of propylene-derived units. In some embodiments, propylene-rich alpha-olefin copolymers having (a) a melting point of less than 90° C.; a relationship of elasticity to 500 percent tensile modulus such that the elasticity is less than or equal to 0.935M+12, where elasticity is in percent and M is the 500 percent tensile modulus in mega Pascal (MPa); and a relationship of flexural modulus to 500 percent tensile modulus such that flexural modulus is less than or equal to 4.2e^{0.27M}+50, where flexural modulus is in MPa and M is the 500 percent tensile modulus in MPa are preferred. In some embodiments the propylene-rich alpha-olefin copolymer comprise 6 to 20 weight percent of ethylene-derived units and 94 to 80 weight percent of propylene-derived units with 92 to 80 weight percent of propylene-derived units preferred. In still other embodiments, polymers comprising 10 to 20 weight percent of ethylene-derived units and 90 to 80 weight percent of propylene-derived units.

In another embodiment, a propylene-rich alpha-olefin copolymer that comprises a copolymer of propylene and at least one comonomer selected from the group consisting of C₂ and C₄ to C₂₀ alpha-olefins, wherein the copolymer has a propylene content of greater then 65 mole percent, a Mw of from about 15, 000 to about 200,000, a Mw/Mn of from about 1.5 to about 4 is preferred.

In an other embodiment, a preferred propylene-rich alpha-olefin copolymer has a heat of fusion of less than about 80 Joule per gram (J/g), preferably from about 8 to about 80, or more preferably from about 8 to about 30 J/g as determined by differential scanning calorimeter (DSC).

A preferred thermoplastic resin is a propylene-based copolymer comprising a propylene and ethylene copolymer made using a nonmetallocene metal-centered, heteroaryl ligand catalyst as described in U.S. Patent Application Publication No. 2003-0204017, which is incorporated by reference herein in its entirety.

Preferably, the propylene-rich copolymer comprises at least about 60 weight percent of units derived from propylene and at least about 0.1 weight percent of units derived from ethylene. The propylene and ethylene copolymers made with such nonmetallocene, metal-centered, heteroaryl ligand catalyst exhibit a unique region-error. The copolymer is characterized as having ¹³C NMR peaks corresponding to a region-error at about 14.6 and about 15.7 parts per million (ppm), which are believed to be the result of stereoselective 2,1-insertion errors of propylene units into the growing polymer chain. In this particularly preferred aspect, these peaks are about equal in intensity, and they typically represent about 0.02 to about 7 mole percent of the propylene insertions into the homopolymer or copolymer chain.

These propylene-rich polymers can be made by a number of processes, such as by single stage, steady state, polymerization conducted in a well-mixed continuous feed polymerization reactor. In addition to solution polymerization, other polymerization procedures such as gas phase or slurry polymerization may be used. Suitable processes for preparing such polymers are described in U.S. Pat. No. 6,525,157, which is incorporated herein by reference in its entirety.

Further, to the thermoplastic resin, known additives such as a colorant, a flow modifier, an antistatic additive, a mold release, an impact modifier, a stabilizer, i.e., heat, light, UV, and the like, a compatibilizer, a filler (other than the fiber-reinforcing material), and the like may suitably be incorporated depending on the particular application or molding/extrusion conditions, and such additives may be used by mixing them with the resin in accordance with a conventional method.

The thermoplastic resin is applied to the long fiber-reinforcing material as an aqueous melt-kneaded thermoplastic dispersion. Aqueous melt-kneaded thermoplastic dispersions are known, for example as disclosed in U.S. patent application Ser. Nos. 10/925693 and 11/068573; and in U.S. Pat. Nos. 6,448,321; 5,798,410; 5,688,842; 5,574,091; and 5,539,021; each of which is incorporated herein by reference in its entirety. The aqueous dispersion comprises, in addition to (A) at least one thermoplastic resin as disclosed hereinabove, (B) at least one dispersing agent, and (C) water. In one embodiment of the aqueous dispersion used in the present invention, it comprises (A) at least one thermoplastic resin; (B) a salt of a higher fatty acid, such as an alkali metal salt of montanic acid; and (C) water. In another embodiment the aqueous dispersion comprises (A) at least one thermoplastic resin; (B) at least one dispersing agent; and (C) water wherein the dispersion has a volume average particle size of less than about 5 micrometers. In another embodiment of the aqueous dispersion used in the present invention, it comprises (A) at least one thermoplastic resin; (B) at least one dispersing agent; and (C) water wherein the dispersion has a pH of less than about 12. In some dispersions according to any embodiment, the dispersing agent comprises less than about 4 percent by weight based on the weight of the thermoplastic resin. In some dispersions having a pH of 12 or less, the dispersion also has a volume average particle size of less than about 5 micrometers. Some dispersions that have a particle size of less than about 5 micrometers also have a pH of less than 12. In still other embodiments, the dispersion has a pH of less than 12, and an average particle size of less than about 5 micrometers, and wherein the dispersing agent comprises less than about 4 percent by weight based on the weight of the thermoplastic resin.

Any suitable dispersing agent can be used. However, in particular embodiments, the dispersing agent comprises at least one carboxylic acid, a salt of at least one carboxylic acid, or carboxylic acid ester or salt of the carboxylic acid ester. One example of a carboxylic acid useful as a dispersant is a fatty acid such as montanic acid, a preferred salt of montanic acid is the alkali metal salt of montanic acid. In some preferred embodiments, the carboxylic acid, the salt of the carboxylic acid, or at least one carboxylic acid fragment of the carboxylic acid ester or at least one carboxylic acid fragment of the salt of the carboxylic acid ester has fewer than 25 carbon atoms. In other embodiments, the carboxylic acid, the salt of the carboxylic acid, or at least one carboxylic acid fragment of the carboxylic acid ester or at least one carboxylic acid fragment of the salt of the carboxylic acid ester has 12 to 25 carbon atoms. In some embodiments, carboxylic acids, salts of the carboxylic acid, at least one carboxylic acid fragment of the carboxylic acid ester or its salt has 15 to 25 carbon atoms are preferred. In other embodiments, the number of carbon atoms is 25 to 60. Some preferred salts comprise a cation selected from the group consisting of an alkali metal cation, alkaline earth metal cation, or ammonium or alkyl ammonium cation.

In still other embodiments, the dispersing agent is selected from the group consisting of ethylene carboxylic acid polymers, and their salts, such as ethylene acrylic acid copolymers or ethylene methacrylic acid copolymers.

In other embodiments, the dispersing agent is selected from alkyl ether carboxylates, petroleum sulfonates, sulfonated polyoxyethylenated alcohol, sulfated or phosphated polyoxyethylenated alcohols, polymeric ethylene oxide/propylene oxide/ethylene oxide dispersing agents, primary and secondary alcohol ethoxylates, alkyl glycosides and alkyl glycerides.

Combinations any of the above-enumerated dispersing agents can also be used to prepare some aqueous dispersions.

Some dispersions described herein have an advantageous particle size distribution. In particular embodiments, the dispersion has a particle size distribution defined as volume average particle diameter (Dv) divided by number average particle diameter (Dn) of less than or equal to about 2.0. In other embodiments, the dispersion has a particle size distribution of less than or equal to about less than 1.5.

The term “dispersion” as used herein is intended to include within its scope both emulsions of essentially liquid materials, prepared by employing the thermoplastic resin and the dispersing agent, and dispersions of solid particles. Such solid dispersions can be obtained, for example, by preparing an emulsion and then causing the emulsion particle to solidify by various means. Thus, when the components are combined, some embodiments provide an aqueous dispersion wherein content of the dispersing agent is present in the range of from 0.5 to 30 parts by weight, and content of (C) water is in the range of 1 to 35% by weight per 100 parts by weight of the thermoplastic polymer; and total content of (A) and (B) is in the range of from 65 to 99% by weight. In particular embodiments, the dispersing agent ranges from 2 to 20 parts by weight based on 100 parts by weight of the polymer. In some embodiments, the amount of dispersing agent is less than about 4 percent by weight, based on the weight of the thermoplastic polymer. In some embodiments, the dispersing agent comprises from about 0.5 percent by weight to about 3 percent by weight, based on the amount of the thermoplastic polymer used. In other embodiments, about 1.0 to about 3.0 weight percent of the dispersing agent are used. Embodiments having less than about 4 weight percent dispersing agent are preferred where the dispersing agent is a carboxylic acid.

One feature of some embodiments of the invention is that the dispersions have a small particle size. Typically the average particle size is less than about 5 micrometer. Some preferred dispersions have an average particle size of less than about 1.5 micrometer. In some embodiments, the upper limit on the average particle size is about 4.5 micrometer, 4.0 micrometer, 3.5 micrometer, 3.75 micrometer, 3.5 micrometer, 3.0 micrometer, 2.5 micrometer, 2.0 micrometer, 1.5 micrometer, 1.0 micrometer, 0.5 micrometer, or 0.1 micrometer. Some embodiments have a lower limit on the average particle size of about 0.05, 0.7 micrometer, 0.1 micrometer, 0.5 micrometer, 1.0 micrometer, 1.5 micrometer, 2.0 micrometer, or 2.5 micrometer. Thus, some particular embodiments have, for example, an average particle size of from about 0.05 micrometer to about 1.5 micrometer. While in other embodiments, the particles in the dispersion have an average particle size of from about 0.5 micrometer to about 1.5 micrometer. For particles that are not spherical the diameter of the particle is the average of the long and short axes of the particle. Particle sizes can be measured on a Coulter LS230 light-scattering particle size analyzer or other suitable device.

While any method may be used, one convenient way to prepare the dispersions described herein is by melt-kneading. Any melt-kneading means known in the art may be used. In some embodiments a kneader, a Banbury mixer, single-screw extruder, or a multi-screw extruder is used. The melt-kneading may be conducted under the conditions which are typically used for melt-kneading the thermoplastic resin (A). A process for producing the dispersions in accordance with the present invention is not particularly limited. One preferred process, for example, is a process comprises melt-kneading the above-mentioned components according to U.S. Pat. No. 5,756,659. A preferred melt-kneading machine is, for example, a multi screw extruder having two or more screws, to which a kneading block can be added at any position of the screws. If desired, it is allowable that the extruder is provided with a first material-supplying inlet and a second material-supplying inlet, and further third and forth material-supplying inlets in this order from the upper stream to the down stream along the flow direction of a material to be kneaded. Further, if desired, a vacuum vent may be added at an optional position of the extruder. In some embodiments, the dispersion is first diluted to contain about 1 to about 3 percent by weight of water and then subsequently further diluted to comprise greater than 25 percent by weight of water. In some embodiments, the further dilution provides a dispersion with at least about 30 percent by weight of water. The aqueous dispersion obtained by the melt kneading may be further supplemented with an aqueous dispersion of an ethylene-vinyl compound copolymer, or a dispersing agent.

The aqueous thermoplastic dispersions described hereinabove may be used as prepared or diluted further with water to provide a thermoplastic resin level equal to or less than about 70 weight percent, preferably equal to or less than about 55, and more preferably equal to or less than about 45 weight percent. The aqueous thermoplastic dispersions described hereinabove may be used as prepared or diluted further with water to provide a thermoplastic resin level equal to or greater than about 10 weight percent, preferably equal to or greater than about 15, and more preferably equal to or greater than about 20 weight percent.

The aqueous dispersion may be coated onto a substrate by various procedures, and for example, by spray coating, curtain flow coating, coating with a roll coater or a gravure coater, brush coating, preferably-dipping or drawing through a bath. The coating is preferably-dried and/or fused by heating the coated substrate to 50° C. to 150° C. for 1 to 300 seconds although the drying and/or fusing may be accomplished by any suitable means including air drying at ambient temperature.

To illustrate the practice of this invention, examples of preferred embodiments are set forth below. However, these examples do not in any manner restrict the scope of this invention.

### EXAMPLES

### Example 1

A continuous glass roving strand (VETROTEX™ RO99 719 available from Saint-Gobain) is unwound from the outside of a standard bobbin. The roving is pulled through an aqueous melt-kneaded thermoplastic dispersion as set forth in FIG. 1 by a Brabender film pull roll unit at a rate of 8 feet per minute (ft/min.). The aqueous dispersion comprises 80 percent by weight deionized water and 20 percent by weight solids. The solids comprise 2.35 weight percent long chain carboxylic acid surfactant and 17.65 weight percent of a propylene-rich propylene and ethylene copolymer (9 percent ethylene) having a density of 0.876 grams per cubic centimeter (g/cc) and a melt flow rate (MFR) (under conditions of 230° C. and an applied load of 2.16 kilograms (Kg)) of 25 grams per 10 minutes (g/10 min.). The average particle size of the dispersion is about 0.61 microns with a polydispersity of 1.31. The pH value of the melt-kneaded aqueous dispersion is 11.6.

The glass roving is pulled through the bath for a distance of about 75 mm. After immersion in and exiting the bath, excess liquid is removed from the coated strand by contact with a fluoropolymer wiper. The wet strand is pulled into a forced air oven maintained at a temperature of 180° C. Inside the oven, the strand is passed over a series of pulleys and guides to provide a sufficient path length for a one minute residence time in the oven. In the oven, the water is driven off and the propylene polymer softened and fused. The dry coated strand emerges from the oven tacky due to the soften polymer coating on the glass fibers. The coated strand quickly cools in the air to a stiff, flat bundle of coated glass fibers. The flat, coated bundle of glass fibers is cut into 12 mm long glass fiber (LGF) concentrate pellets using a air-powered fiberglass chopper gun. The Brabender puller is located after the oven and before the chopper gun. The glass content of this sample is determined by ashing the pellets at 550° C. for two hours in a muffle furnace. The glass level is determined as the residual weight after removal of the organic coating and is 90.8 percent.

The LGF concentrate pellets (33 parts) are dry blended with 7.5 parts polypropylene homopolymer pellets (available from The Dow Chemical Company as 5E16S PolyPropylene Resin, 35 MFR-“5E16S”), 7.5 parts polypropylene homopolymer pellets (available from The Dow Chemical Company as DX5E30S PolyPropylene Resin, 75 MFR-“DX5E30S”), 2 parts maleic anhydride grafted polypropylene pellets (available from Crompton as POLYBOND™ 3200-“POLYBOND 3200”), and 50 parts polypropylene and ethylene copolymer pellets (available from The Dow Chemical Company as 7C54H PolyPropylene Resin, 12 MFR-“7C54H”) and shaken in a plastic bag. This mixed pellet blend is placed in the feed hopper of a Toyo PLASTAR™SI-90 plastic injection molding machine equipped with a mold containing twin drops for a standard ASTM tensile-bar and a two inch diameter optical disk. Parts are molded from this compound using a temperature profile of 395° F. (202° C.) closest to the hopper to 385° F. (196° C.) by the nozzle. The mold temperature is 100° F., the hold time is 15 seconds, and the back pressure used is 250 pounds per square inch (psi). The parts produced are off-white in color and homogeneous in appearance, with a smooth surface and no visible accumulations of glass fiber.

### Example 2

Example 2 is run the same as Example 1 with the exception that the strand after exiting the oven is passed though a rounding die and cools in the air to a stiff, round strand. A Killion tube puller is utilized rather than the Brabender film pull roll unit and the Killion tube puller is located after the rounding die and before the cutter. The glass level is determined to be 90.7 percent based on the weight of the long glass thermoplastic concentrate.

### Example 3

Example 3 is run the same as Example 2 with the exception that the amounts of polypropylene homopolymer pellets (5E16S), polypropylene homopolymer pellets (DX5E30S), and polypropylene and ethylene copolymer pellets (7C54H) are 9, 9, and 47 weight percent, respectively. The glass level is in the concentrate is determined to be 90.7 percent based on the weight of the long glass thermoplastic concentrate.

### Example 4

Example 4 is run the same as Example 2 with the exception that two glass roving strands are coated. The glass level is determined to be 90.7 percent based on the weight of the long glass thermoplastic concentrate.

The compositions of the LGF concentrates of Examples 1 to 4 are listed in Table 1. The properties of molded test specimens comprising said LGF concentrates are tested according to the following test methods and the properties are reported in Table 1.

“Izod” impact resistance as measured by the “notched” and “unnotched” Izod test is determined according to ASTM D 256-90-B at 23° C. Notched specimens are notched with a TMI 22-05 notcher to give a 0.254 mm radius notch. A 0.91 kilogram pendulum is used. The values are reported in foot pounds per inch (ft-lb/in).

“Dart” instrumented impact resistance is measured according to ASTM D 3763 on a MTS 810 instrumented impact tester at 15 miles per hour (MPH) impact. Test results are determined at 23° C. Test results are reported in inch-pounds (in-lb).

Flexural modulus (“Fm”) and flexural strength (“Fs”) are measured according to ASTM D 790. Test results are reported in pounds per square inch (psi).

Tensile elongation (“Te”), tensile modulus (“Tm”) and tensile strength (“Ts”) are measured according to ASTM D 638. Te results are reported in percent (%) and Tm and Ts results are reported in psi.

Deflection temperature under load (“DTUL”) is measured according to ASTM D 648 on unannealed samples at 264 psi (1.8 mega Pascal (MPa)). Results are reported in degrees Fahrenheit (° F.).

“Ash” is measured according to ASTM D 5650 and is reported in %.

TABLE 1

| | Example | | | |
|---|---|---|---|---|
| | 1 | 2 | 3 | 4 |
| COMPONENT | | | | |
| 7C54H | 50 | 50 | 47 | 50 |
| 5E16S | 7.5 | 7.5 | 9 | 7.5 |
| DX5E30S | 7.5 | 7.5 | 9 | 7.5 |
| LGF-single strand-flat | 33 | | | |
| LGF-single strand-round | | 33 | 33 | |
| LGF-double strand-round | | | | 33 |
| POLYBOND 3200 | 2 | 2 | 2 | 2 |
| PROPERTY | | | | |
| Fm, 10⁵ psi | | 7.64 | 7.68 | 7.87 |
| Fs, psi | | 18,500 | 18,700 | 18,700 |
| Te, % | | 3 | 3 | 3 |
| Tm, 10⁵ psi | | 7.88 | 8.05 | 6.92 |
| Ts, psi | | 11,200 | 11,700 | 10,800 |
| Notched Izod, ft-lb/in | 3.2 | 4.7 | 4.7 | 5.0 |
| Unnotched Izod, ft-lb/in | | 14.9 | 15.9 | 16.1 |
| Dart | | | | |
| Peak Energy, in-lb | 51 | 59 | 62 | 79 |
| Total Energy, in-lb | 105 | 109 | 118 | 123 |
| DTUL, ° F. | | 301 | 301 | 303 |

1. A method to make a long fiber concentrate comprising fibers and a thermoplastic resin comprising the steps of:
i coating continuous fibers with an aqueous melt-kneaded thermoplastic dispersion to form thermoplastic coated continuous fiber strands,
ii heating the thermoplastic coated continuous fiber strands,
iii chopping the dried thermoplastic coated continuous fiber strands forming dried long fiber concentrate pellets, and
iv isolating dried long fiber concentrate pellets.

2. A method to make a long fiber concentrate comprising fibers and a thermoplastic resin comprising the steps of:
i coating continuous fibers with an aqueous melt-kneaded thermoplastic dispersion to form thermoplastic coated continuous fiber strands,
ii chopping the thermoplastic coated continuous fiber strands forming fiber concentrate pellets,
iii heating the fiber concentrate pellets, and
iv isolating dried long fiber concentrate pellets.

3. The method of claims 1 or 2 wherein the aqueous melt-kneaded thermoplastic dispersion comprises a thermoplastic resin, a dispersing agent, and water.

4. The method of claim 3 wherein the thermoplastic resin is polyethylene, polypropylene, polyamide, polyethylene terephthalate, polybutylene terephthalate, a styrene and acrylonitrile copolymer, an acrylonitrile, styrene, and butadiene terpolymer, polyphenylene oxide, polyacetal, polyetherimide, polycarbonate, or blends thereof.

5. The method of claim 3 wherein the thermoplastic polyethylene resin is an ethylene and alpha-olefin copolymer.

6. The method of claim 5 wherein the thermoplastic polyethylene resin is a substantially linear ethylene polymer or a linear ethylene polymer.

7. The method of claim 3 wherein the thermoplastic polypropylene resin is a propylene-rich and alpha-olefin copolymer.

8. The method of claim 7 wherein the thermoplastic polypropylene-rich resin is a propylene and ethylene copolymer comprising at least about 60 weight percent of units derived from propylene and at least about 0.1 weight percent of units derived from ethylene made using a nonmetallocene metal-centered, heteroaryl ligand catalyst characterized as having ¹³C NMR peaks corresponding to a region-error at about 14.6 and about 15.7 parts per million wherein these peaks are about equal in intensity.

9. The method of claim 3 wherein the aqueous melt-kneaded thermoplastic dispersion comprises from about 10 to about 70 weight percent thermoplastic resin.

10. The method of claim 3 wherein the dispersing agent is a carboxylic acid, a salt of a carboxylic acid, a carboxylic acid ester, a salt of an acid ester, an ethylene carboxylic acid polymer, a salt of an ethylene carboxylic acid polymer, an alkyl ether carboxylate, a petroleum sulfonate, a sulfonated polyoxyethylenated alcohol, a sulfated polyoxyethylenated alcohol, a phosphated polyoxyethylenated alcohol, a polymeric ethylene oxide/propyleneoxide/ethylene oxide dispersing agent, a primary alcohol ethoxylate, a secondary alcohol ethoxylate, an alkyl glycoside, an alkyl glyceride, or combinations thereof.

11. The method of claim 3 wherein the dispersing agent is montanic acid, an alkali metal salt of montanic acid, an ethylene acrylic acid copolymer, an ethylene methacrylic acid copolymer, or combinations thereof.

12. The method of claim 3 wherein the dispersion has a volume average particle size of less than about 5 micrometers.

13. The method of claim 3 wherein the dispersion has a pH of less than 12.

14. The method of claim 3 wherein the dispersion has a volume average particle size of less than about 5 micrometers, a pH of less than about 12, and the dispersing agent comprises less than about 4 percent by weight based on the weight of the thermoplastic resin.

15. The method of claim 1 or 2 wherein the continuous fiber is a natural fiber, a glass fiber, a carbon fiber, a polypropylene fiber; a polyamide fiber, a polytetrafluoroethylene fiber, a polyester fiber, or an ultra high molecular weight polyethylene fiber.

16. The method of claim 12 wherein the continuous fiber is a glass fiber.

17. A method to make a long fiber concentrate comprising fibers and a thermoplastic resin comprising the steps of:
i coating chopped long fibers with an aqueous melt-kneaded thermoplastic dispersion to form thermoplastic coated chopped fiber pellets,
ii heating the coated chopped long fiber concentrate pellets, and
iii isolating dried long fiber concentrate pellets.

18. A long fiber-reinforced thermoplastic concentrate of claim 1, 2, or 17 comprising a fiber level of between 85 to 99 weight percent based on the weight of the long fiber-reinforced thermoplastic concentrate.

19. A long fiber-reinforced thermoplastic composition comprising a thermoplastic resin and the long fiber-reinforced thermoplastic concentrate of claims 1, 2, or 17.

20. A method for producing a long fiber-reinforced thermoplastic article comprising the steps of:
i dry blending the long fiber-reinforced thermoplastic concentrate of claims 1, 2, or 17 with a non-reinforced thermoplastic resin and
ii injection molding, blow molding, or extruding said blend to form an injection molded, blow molded, or extruded long fiber-reinforced thermoplastic article.

21. A molded or extruded thermoplastic article comprising the long fiber-reinforced thermoplastic concentrate of claims 1, 2, or 17.
